(19) United States
(12) Patent Application Publication
(10) Pub. No.: US 2013/0088125 A1
(43) Pub. Date: Apr. 11, 2013

(54) DRIVING DEVICE FOR AN ELECTRIC EYELASH BRUSH

(71) Applicant: ERIC SHIH, Changhua City (TW)

(72) Inventor: ERIC SHIH, Changhua City (TW)

(21) Appl. No.: 13/270,231

(22) Filed: Oct. 11, 2011

(51) Int. Cl. H02K 23/66

(52) U.S. Cl. 310/68 A

(57) ABSTRACT

An electric eyelash brush includes a rotatable member, a contact plate unit, a connector and a motor. The rotatable member has multiple holes on the top thereof and multiple ribs extend upward from outside periphery of the rotatable member. The contact plate unit has two contact plates and each contact plate has a horizontal end and a vertical end which abut against the inside of the hole. The horizontal end has two contact points respectively located on two sides thereof and the contact points are located on the top of the rotatable member. The connector has multiple slots corresponding to the ribs. The motor has a shaft at one end and has two conductive plates at another end. The motor is connected to the connector and the conductive plates are passing through the connector and corresponding to the contact plate unit.

### BACKGROUND OF THE INVENTION

1. Field of the Invention

The present invention relates to a driving device and more particularly to a driving device for an electric eyelash brush.

2. Description of Related Art

A conventional electric eyelash brush includes a cover with a space defined therein, a movable member located in the space, a power cell for providing power to the eyelash brush, a body receiving the power cell. The body has a slot defined on the lateral thereof The movable member is engaged with the slot. The body is rotated with the rotation of the cover. A conductive unit is located in the body and electrically connected with the power cell. A motor includes two end points and a shaft The two end points are attached to the conductive unit so as to decide the status of the shaft. However, the conventional electric eyelash brush has two shortcomings as following:

First, the structure of the conventional electric eyelash brush is complicated and not stable so that the conventional electric eyelash brush might be broken after long-term use.

Second, the structure of the conventional electric eyelash brush is complicated so that it spends much time manufacturing the conventional electric eyelash brush.

The present invention has arisen to mitigate and/or obviate the disadvantages of the conventional electric eyelash brush.

### SUMMARY OF THE INVENTION

The main objective of the present invention is to provide an improved driving device.

To achieve the objective, a driving device for an electric eyelash brush comprises a rotatable member having multiple holes defined on the top thereof and multiple ribs extending upward from an outside periphery of the rotatable member, a contact plate unit having two contact plates and each contact plate having a horizontal end and a vertical end which abuts against the inside wall of the hole corresponding thereto, the horizontal end has two contact points respectively located on two sides thereof and the contact points located on the top of the rotatable member, a connector having multiple slots which are located on the outside periphery thereof and corresponding to the ribs, a motor having a shaft on one end thereof and two conductive plates located on two sides of another end thereof, the motor connected to the connector at another end thereof and the conductive plates passing through the connector and corresponding to the contact plate unit, the rotatable member having multiple bosses on the top thereof and the bosses abutting against the contact points to position the contact points, the motor having a guide pin which is located at another end thereof, the connector having a through hole passing through the bottom thereof and the through hole being shaped to be corresponding to the conductive plate and the guide pin.

Wherein the ribs move in the slot via the rotation of the rotatable member to change the direction of the contact points which are driven by the rotatable member and the conductive plates are attached to the contact points or separated from the contact points, such that the operation of the shaft is adjusted and controlled.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of the electric eyelash brush of the present invention;

FIG. 2 is another exploded view of the electric eyelash brush of the present invention;

FIG. 3 shows the connection of the rotatable member and the contact plate unit;

FIG. 4 shows the status of the contact points when the eyelash brush is not in use;

FIG. 5 shows the operation of the electric eyelash brush of the present invention;

FIG. 6 is a cross sectional view of the electric eyelash brush of the present invention;

FIG. 7 shows the status of the contact points when the eyelash brush is rotated clockwise; and

FIG. 8 shows the status of the contact points when the eyelash brush is rotated anti-clockwise.

### DETAILED DESCRIPTION OF THE INVENTION

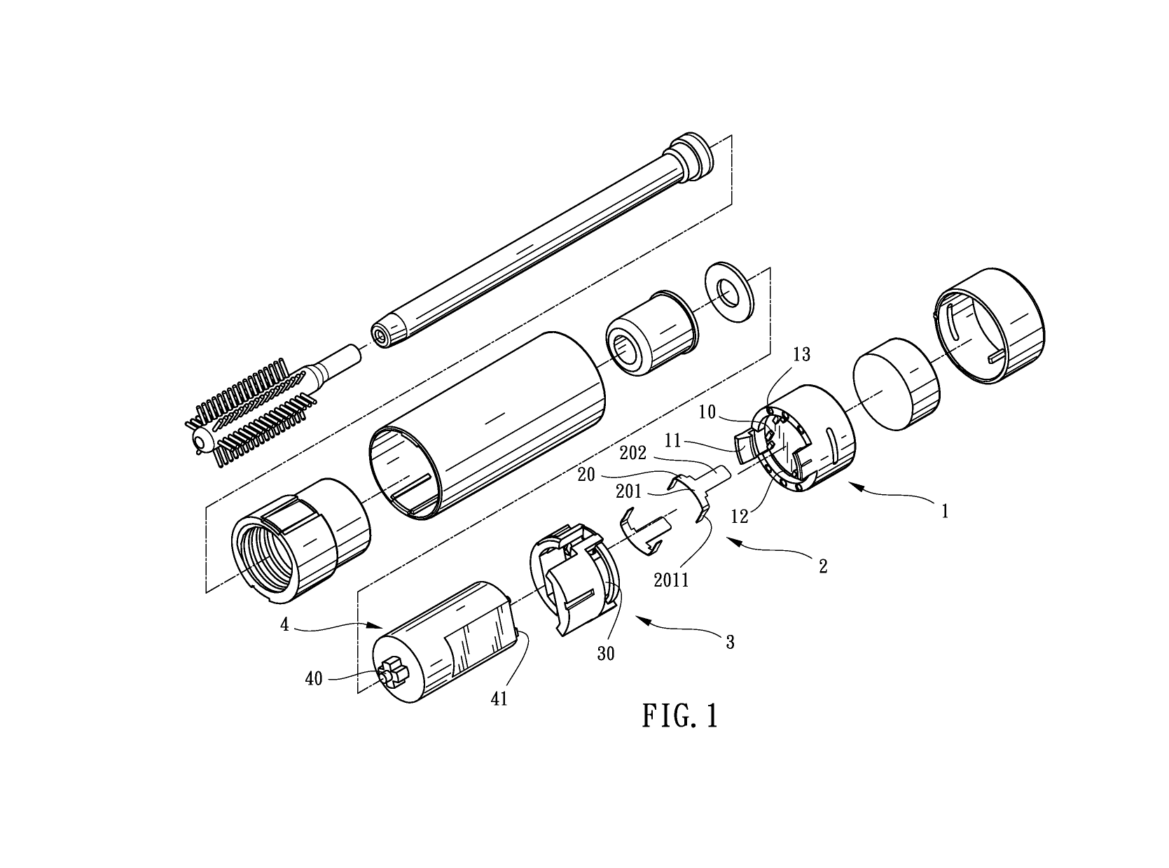

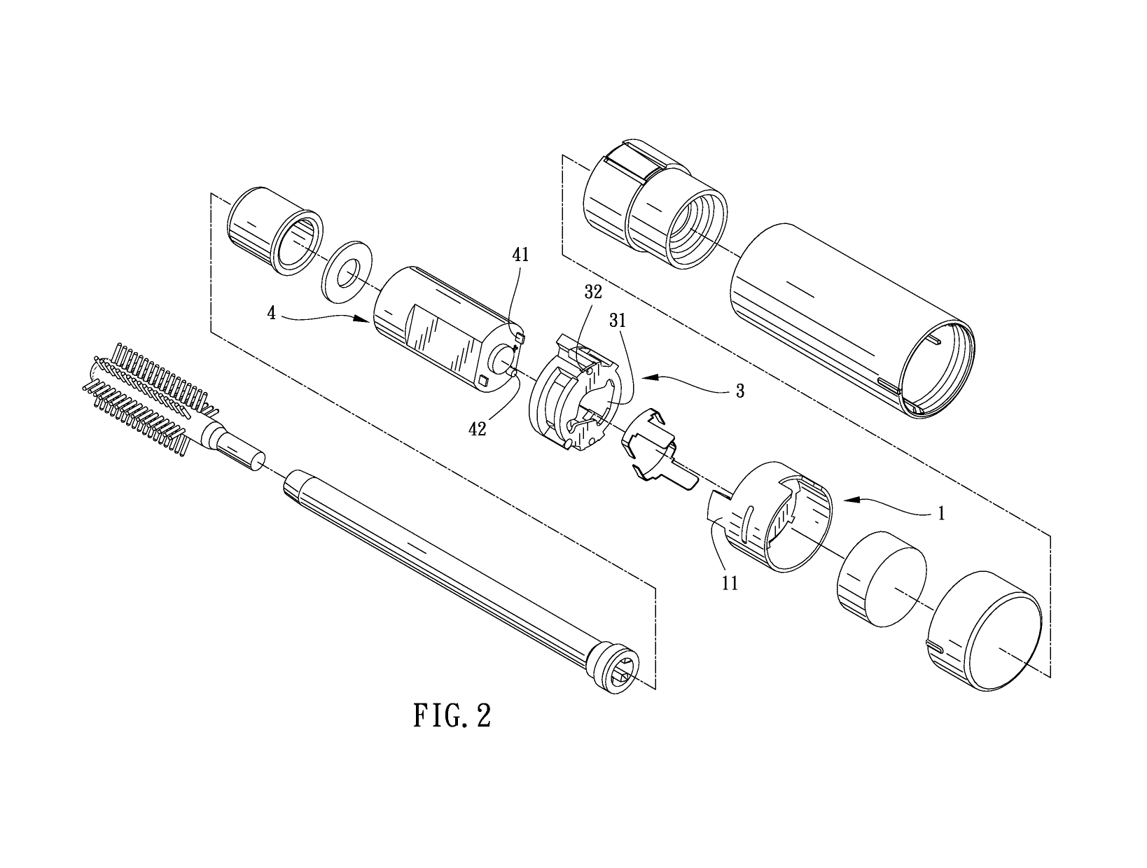

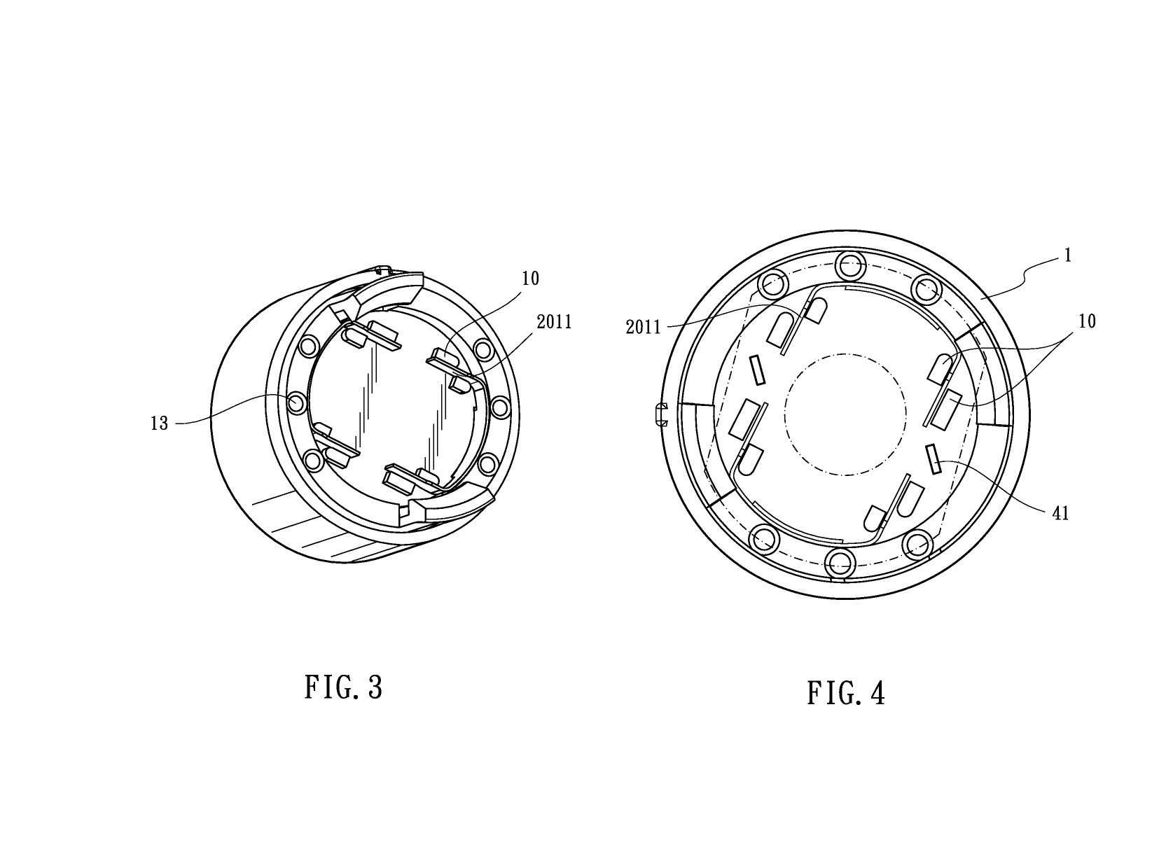

Referring to FIGS. 1-3, a driving device for an electric eyelash brush in accordance with the present invention comprises a rotatable member 1, a contact plate unit 2, a connector 3 and a motor 4. The rotatable member 1 has two holes 12 defined on the top thereof Two ribs 11 extend upward from the outside periphery of the rotatable member 1 and are corresponding to each other. Six recesses 13 are located on the top of the rotatable member 1 and divided into two set of thee recesses 13 located between the ribs 11. One set of thee recesses 13 corresponds to another set of thee recesses 13. The rotatable member 1 further includes eight bosses 10 on the top thereof

The contact plate unit 2 has two contact plates 20 and each contact plate 20 has a horizontal end 201 and a vertical end 202 which abuts against the inside of the hole 12 corresponding thereto. The horizontal end 201 has two contact points 2011 respectively located on two sides thereof and the contact points 2011 are located on the top of the rotatable member 1. Each contact point 2011 is abutted against two bosses 10 at two sides thereof

The connector 3 has two slots 30 defined on the outside periphery thereof and corresponding to the ribs 11 and each rib 11 has an inclined inside which is a convex so as to engage with the slot 30 so that the rotatable member 1 is connected to the connector 3. The connector 3 has two protrusions 32 formed on two sides of the bottom thereof and the protrusions 32 are corresponding to the slots 13. By rotating the rotatable member 1, the ribs 11 move within the slots 30 to change the direction of the contact points 2011.

The motor 4 has a shaft 40 on one end thereof and two conductive plates 41 and a guide pine 42 are located at another end of the motor 4. The conductive plate 41 is corresponding to the guide pine 42. The connector 3 has a through hole 31 opened on the bottom thereof and the through hole 31 is shaped to be corresponding to the conductive plates 41 and the guide pin 42. Another end of the motor 4 is connected to the connector 3 and the conductive plates 41 pass through the connector 3 and are corresponding to the contact plate unit 2. The conductive plates 41 and the guide pin 42 are engaged with the through hole 31 so that the motor 4 does not rotate relative to the connector 3. By this arrangement, when rotating the rotatable member 1, the contact points 2011 are attached to or separated from the conductive plates 41 via the rotation of the rotatable member 1, such that the operation of the shaft 40 is controlled.

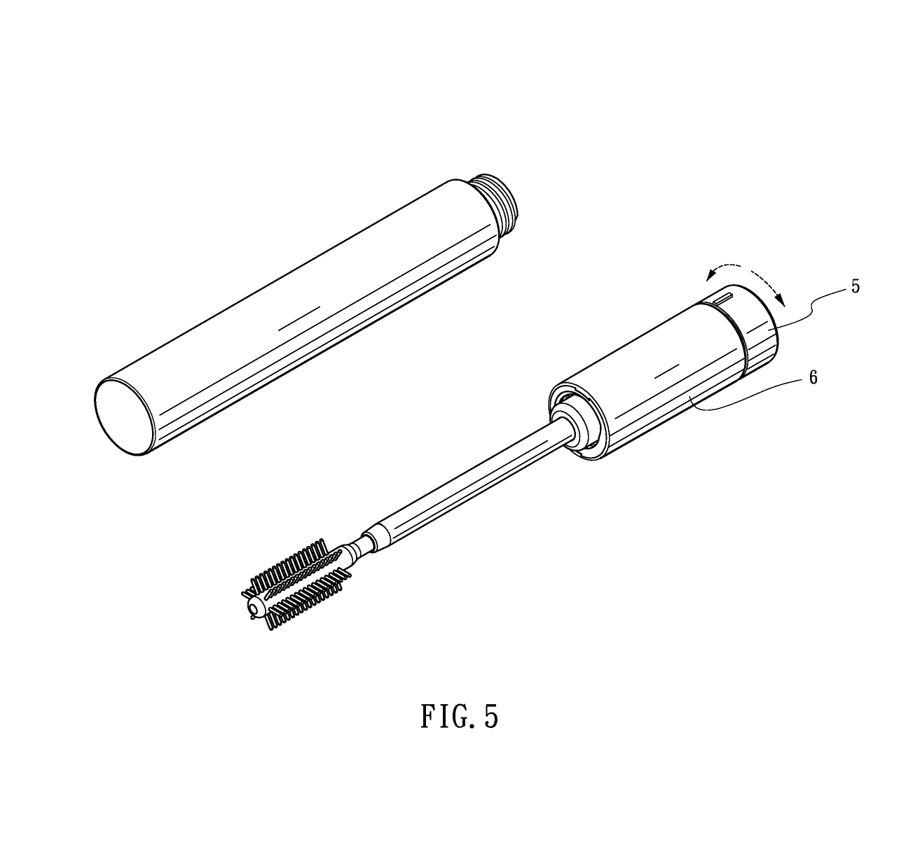

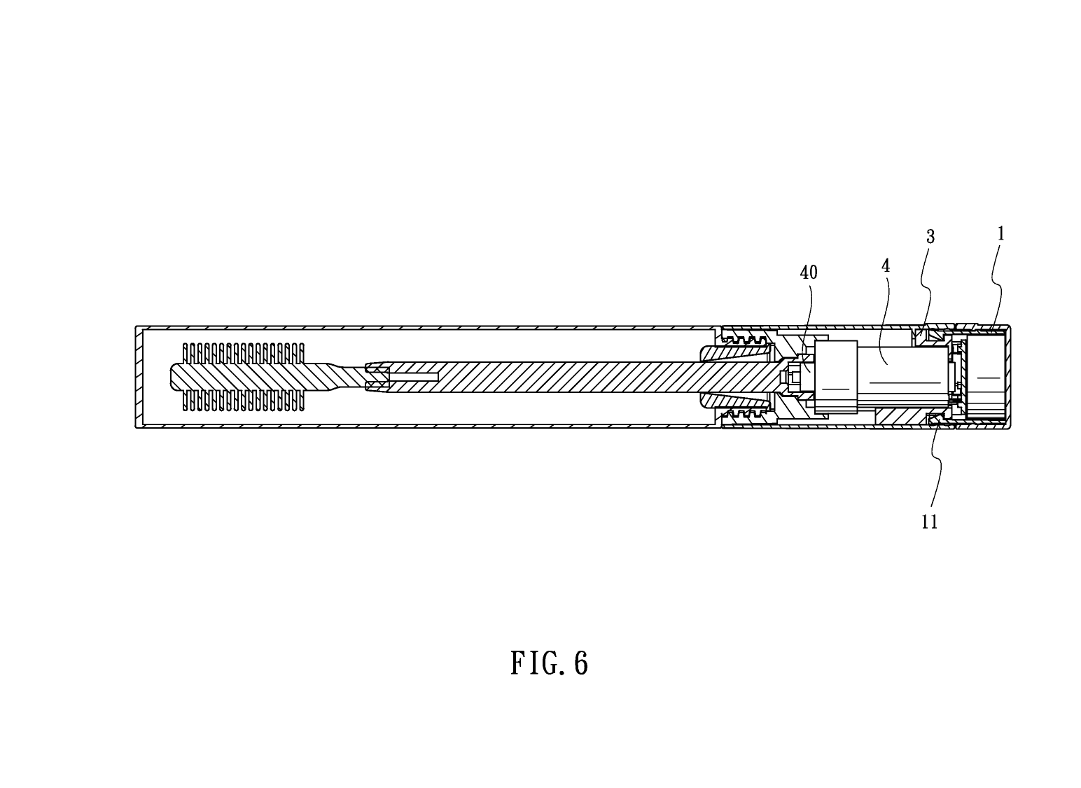

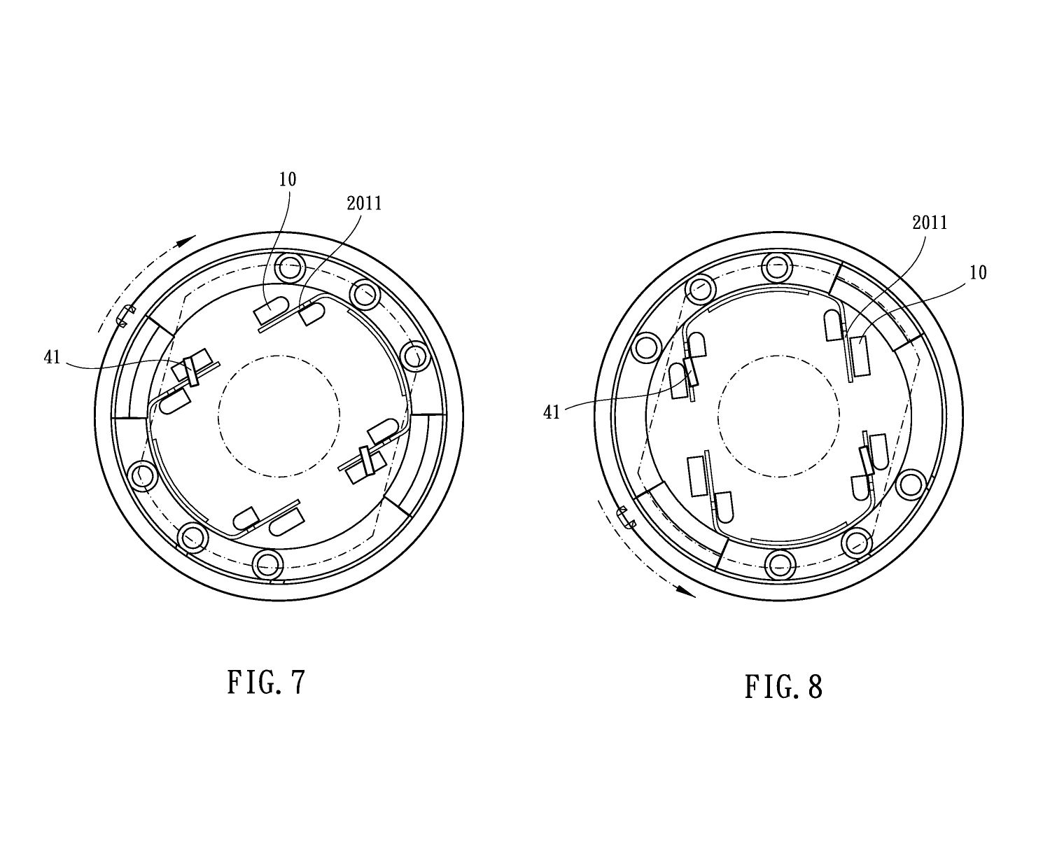

As shown in FIGS. 4-8, a switch cover 5 is mounted to the rotatable member 1 and a case 6 encircles the connector 3 and the motor 4. The switch cover 5 is rotated clockwise or anti-clockwise relative to the case 6 to rotate the rotatable member 1 relative to the connector 3 so that the motor 4 rotates clockwise or anti-clockwise, or stops.

The motor 4 has three statuses, when the switch cover 5 is rotated clockwise relative to the case 6 to rotate the rotatable member 1 clockwise relative to the connector 3, the relative positions between the contact points 2011 and the conductive plates 41 are changed. The two conductive plates 41 are contacted with the contact points 2011 to drive the shaft 40 of the motor 4 in one direction.

When the switch cover 5 is rotated anti-clockwise relative to the case 6, the relative position between the contact points 2011 and the conductive plates 41 are changed. The two conductive plates 41 are contacted with the contact points 2011 in another direction to drive the shaft 40 of the motor 4 in another direction. When the rotatable member 1 is rotated until the contact points 2011 is separated from the conductive plates 41, the motor 4 stops.

The rotatable member 1 has three positions for three rotation modes, which are clockwise, anti-clockwise and mediate portion. The shaft 40 of the motor 4 rotates clockwise, anti-clockwise and stops corresponding to the positions of the rotatable member 1. When the rotatable member 1 is not rotated, the protrusions 32 are respectively engaged with the corresponding set of the slots 13. Therefore, when the position of the rotatable member 1 is changed, the protrusions 32 are respectively engaged with the other corresponding set of the slots 13. Therefore, the rotatable member 1 does not slip relative to the connector 3 under any status so as to keep the status of the motor 4.

Although the invention has been explained in relation to its preferred embodiment, it is to be understood that many other possible modifications and variations can be made without departing from the spirit and scope of the invention as hereinafter claimed.

What is claimed is:

1. A driving device for an electric eyelash brush comprising:
a rotatable member having multiple holes defined on the top thereof and multiple ribs extending upward from an outside periphery of the rotatable member;
a contact plate unit having two contact plates and each contact plate having a horizontal end and a vertical end which abuts against the inside wall of the hole corresponding thereto, the horizontal end has two contact points respectively located on two sides thereof and the contact points located on the top of the rotatable member;
a connector having multiple slots which are located on the outside periphery thereof and corresponding to the ribs; and
a motor having a shaft on one end thereof and two conductive plates located on two sides of another end thereof, the motor connected to the connector at another end thereof and the conductive plates passing through the connector and corresponding to the contact plate unit;
wherein the ribs move in the slot via the rotation of the rotatable member to change the direction of the contact points which are driven by the rotatable member and the conductive plates are attached to the contact points or separated from the contact points, such that the operation of the shaft is adjusted and controlled.

2. The electric eyelash brush as claimed in claim 1, wherein the rotatable member has multiple bosses on the top thereof and the bosses abut against the contact points to position the contact points.

3. The electric eyelash brush as claimed in claim 1, wherein the motor has a guide pin which is located at another end thereof; the connector has a through hole passing through the bottom thereof and the through hole is shaped to be corresponding to the conductive plate and the guide pin.
